(19) United States
(12) Patent Application Publication
(10) Pub. No.: US 2008/0063842 A1
(43) Pub. Date: Mar. 13, 2008

(54) REPOSITIONABLE PRIVACY NOTE

(75) Inventors: Andrew J. Callinan, Shoreview, MN (US); Patricia R. Konsti, Oakdale, MN (US); Constance J. Nelson, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/530,994

(22) Filed: Sep. 12, 2006

(51) Int. Cl. B32B 23/02

(52) U.S. Cl. 428/192

(57) ABSTRACT

A repositionable privacy note is provided. In one exemplary embodiment, the note includes a substrate having opposing first and second surfaces, top and bottom edges, and a folding region disposed between the top and bottom edges creating in the note a top portion between the folding region and the top edge and a bottom portion between the folding region and the bottom edge. The note also includes a first privacy adhesive disposed on the first surface of the substrate. The note further includes a repositionable adhesive disposed on the second surface of the substrate.

### FIELD ON INVENTION

The present invention relates to a repositionable privacy note that allows an individual to communicate a private message to an intended recipient. The note is created by folding a bottom portion of the note forward (towards a user as (s)he has a head-on view of the note) to meet a top portion of the note. The note can also provide tamper proof evidence.

### BACKGROUND

Repositionable notes, such as Post-it® Notes from 3M Company, St. Paul, Minn. have proliferated in work life and home life finding many uses. For example, people can leave messages for others on a Post-it® Note, formulate a To-Do list or groceries list, and use them for temporary markers for books, magazines and the like. Pads of repositionable notes are formed by stacking the notes on top of one another, and optionally stacked in a fan-fold configuration. Individual notes in the pads can then be dispensed from a dispenser. The repositionable notes are commercially available in a multitude of colors and shapes, from polygonal to die cut shapes such as flowers, hearts, and the like. The notes can further include pre-printed images and designs.

### SUMMARY

While repositionable notes have become a useful communication tool, there is a continuing need to advance the functionality of communication tools. In particular, it would be useful to have a repositionable note that can conceal the message written on the note until an intended recipient receives the note, thereby delivering a private message. Also, it would be desirable for such a private repositionable note to have features that alert the intended recipient if the note has been tampered.

In one aspect, the present invention relates to a repositionable privacy note comprising: (a) a substrate having opposing first and second surfaces, top and bottom edges, and a folding region disposed therebetween creating in the note a top portion between the folding region and the top edge and a bottom portion between the folding region and the bottom edge; (b) a first privacy adhesive disposed on the first surface of the substrate; and (c) a repositionable adhesive disposed on the second surface of the substrate.

In another aspect, the present invention relates to a method of using a repositionable privacy note comprising the steps of: (a) providing a repositionable privacy note as described in the preceding paragraph, (b) transcribing a message on the first surface of the substrate; (c) folding the note such that the first surface of the top portion is proximate to the first surface of the bottom portion; and (d) adhering the note to a display surface such that the repositionable adhesive contacts the display surface.

In yet another aspect, the present invention relates to a repositionable privacy note comprising: (a) a substrate having opposing first and second surfaces, top and bottom edges, and a folding region disposed therebetween creating in the note a top portion between the folding region and the top edge and a bottom portion between the folding region and the bottom edge; (b) means for attaching the top portion to the bottom portion such that their respective first surfaces are proximate to each other; (c) a repositionable adhesive disposed on the second surface of the substrate near the top edge; and (d) a first release coating disposed on the first surface of the substrate opposing the repositionable adhesive.

In yet another aspect, the present invention relates to a repositionable privacy note comprising a substrate having opposing first and second surfaces, top and bottom edges, and a folding region disposed therebetween creating in the note a top portion between the folding region and the top edge and a bottom portion between the folding region and the bottom edge; (b) a plurality of openings in the substrate disposed near the bottom edge of the substrate; (c) a primer coating disposed on the first surface covering the substrate at least in between the openings; and (d) a repositionable adhesive disposed on the second surface of the substrate.

In use, at least one of the first and second surfaces of the substrate is the writing surface. In the various embodiments described herein, typically, the first surface is the major writing surface where a user would transcribe a desired message that will be concealed. Optionally the second surface of the substrate can also include a message, if desired.

In this document, the term “about” is presumed to modify all numerical values.

### DETAILED DESCRIPTION

The invention can be better described with reference to the following drawings wherein:

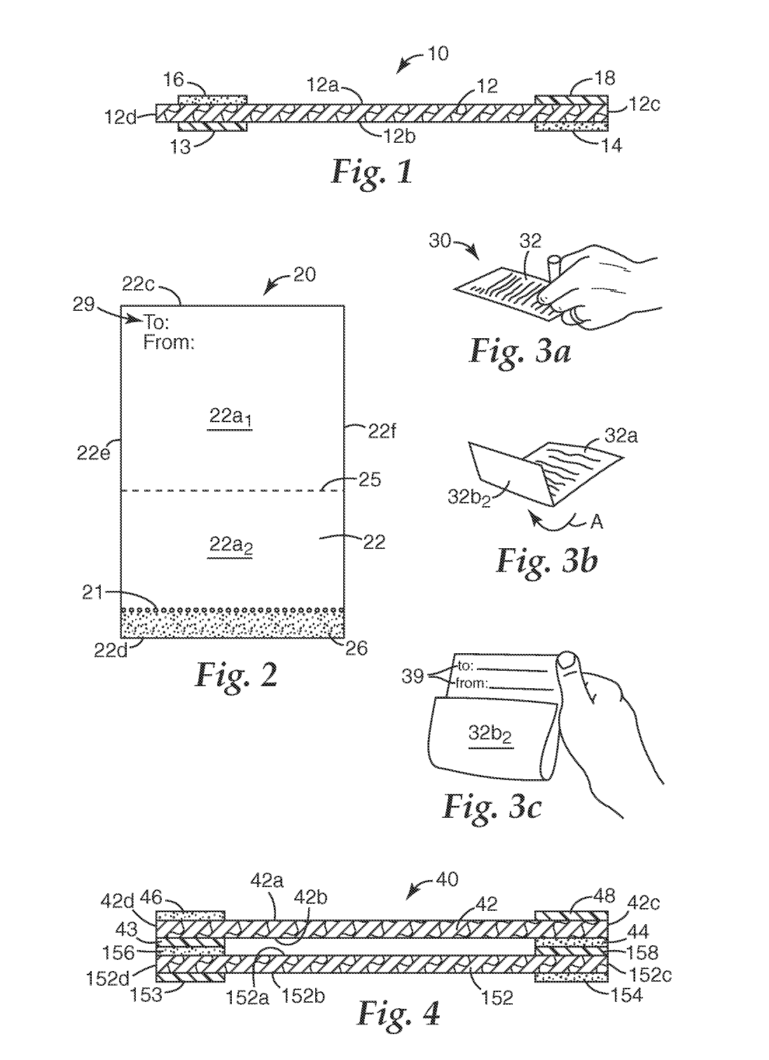

FIG. 1 is a cross-sectional view of an exemplary embodiment of a repositionable privacy note;

FIG. 2 is a top plan view of another exemplary embodiment of a repositionable privacy note;

FIGS. 3a, 3b, and 3c are schematic views of an exemplary method of using an exemplary embodiment of a repositionable privacy note;

FIG. 4 is cross-sectional view of an exemplary pad of repositionable privacy notes;

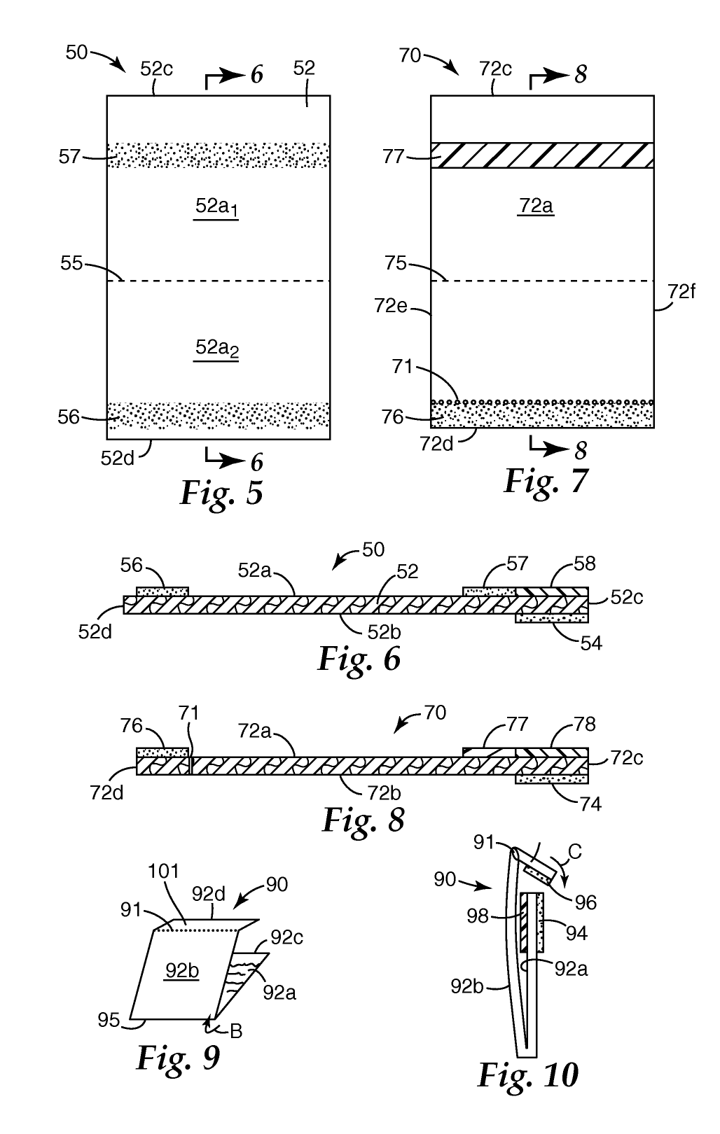

FIG. 5 is a top plan view of another exemplary embodiment of a repositionable privacy note;

FIG. 6 is a cross-sectional view of the embodiment of FIG. 5 taken along line 6-6;

FIG. 7 is a top plan view of another exemplary embodiment of a repositionable privacy note;

FIG. 8 is a cross-sectional view of the embodiment of FIG. 7 taken along line 8-8;

FIG. 9 is a schematic view of an exemplary method of using the embodiment of FIG. 7 and also showing a folding progression of the note;

FIG. 10 is another schematic view of the embodiment of FIG. 7 in a nearly completely folded state;

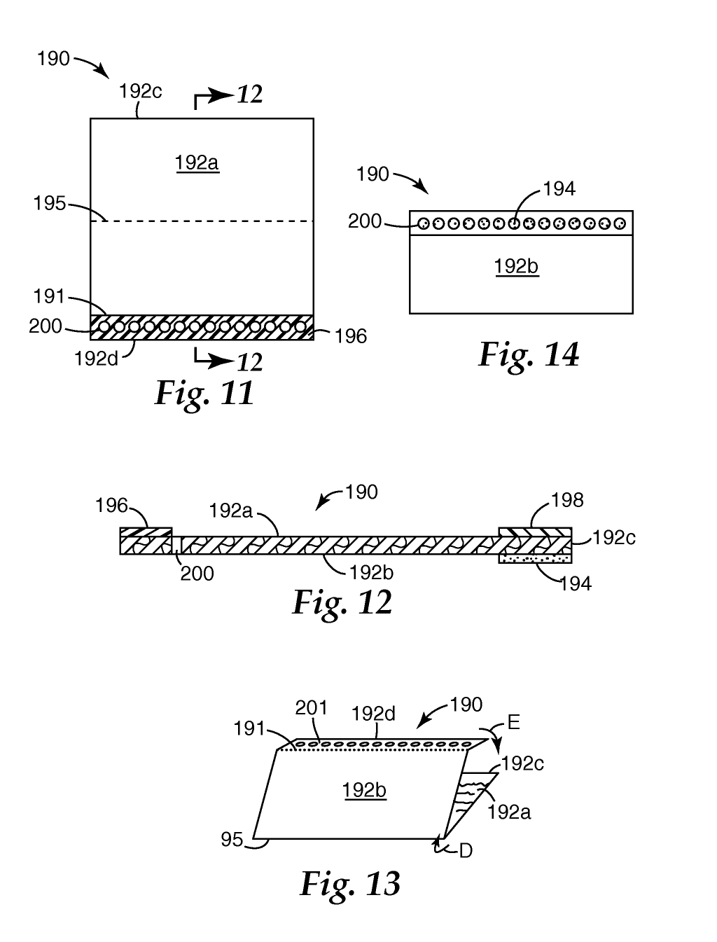

FIG. 11 is a top plan view of another exemplary embodiment of a repositionable privacy note;

FIG. 12 is a cross-sectional view of the embodiment of FIG. 11 taken along line 12-12;

FIG. 13 is a schematic view of an exemplary method of using the embodiment of FIG. 11 and also showing a folding progression of the note; and

FIG. 14 is a back plan view of note of FIG. 11 when the note is completely folded.

These figures are idealized, are not drawn to scale, and are intended merely for illustrative purposes.

### DETAILED DESCRIPTION

FIG. 1 shows a cross-sectional view of an exemplary repositionable privacy note 10. The note includes a substrate 12 having opposing first and second surfaces, 12a and 12b respectively, and top and bottom edges, 12c and 12d respectively. As used herein, the terms “top” and “bottom” are intended only for relative positions on the substrate or on the note. A first privacy adhesive 16 is disposed on the first surface of the substrate. In one embodiment, the first privacy adhesive lies proximate to the bottom edge. In this particular embodiment, the first adhesive is set in slightly from the bottom edge. A repositionable adhesive 14 is disposed on the second surface of the substrate. In one embodiment, the repositionable adhesive is disposed proximate the top edge. In one embodiment, the repositionable adhesive is immediately adjacent to the top edge. A first release coating 18 is disposed on the first surface of the substrate proximate to the top edge and opposing the repositionable adhesive. The term “opposing” means that the first release coating covers generally the same area on the first side of the substrate as the repositionable adhesive covers on the second side of the substrate. In one embodiment, the first release coating is immediately adjacent to the top edge. This particular construction is very useful for forming a pad of repositionable privacy notes, as further described herein. Optionally, a second release coating 13 is disposed on the second surface of the substrate opposing the first privacy adhesive. Depending on the adhesion level between the first privacy adhesive and the substrate, the repositionable privacy note can further provide tamper proof evidence. In other words, the first privacy adhesive can be selected to adhere aggressively to the substrate such that upon disassembly of the note, the substrate will curl or tear.

FIG. 2 shows a top plan view of another exemplary repositionable privacy note 20. The note 22 includes first surface 22a and second surface (not shown), top and bottom edges, 22c, 22d respectively and first side and second side edges 22e, 22f respectively. The note further includes a folding region, indicated generally as imaginary line 25, disposed between the top and bottom edges. The presence of the folding region creates a top portion between the folding region and the top edge, and a bottom portion between the folding region and the bottom edge. The folding region lies generally in the middle of the note. Reference numbers 22a₁ and 22a₂ denote the first surface of the top portion and the first surface of the bottom portion, respectively. A first privacy adhesive 26 is disposed on the first surface of the substrate proximate to the bottom edge. In one embodiment, the first privacy adhesive is immediately adjacent to the bottom edge. The note includes a perforation 21 disposed proximate to the first privacy adhesive. In one embodiment, the perforation is disposed immediately adjacent to the first privacy adhesive and distal to the bottom edge such that the perforation lies between the first privacy adhesive and the folding region 25. In one embodiment, the first privacy adhesive and the perforations extend from the first to the second side edges. A repositionable adhesive (not shown) is disposed on the second surface of the substrate near the top edge. Optionally, the note 20 further includes a first release coating (not shown) disposed on the first surface 22a₁ of the note opposing the repositionable adhesive. Optionally, the first surface of the note includes pre-printed indicia, generally indicated as reference number 29. In this particular embodiment, the indicia are printed near the top edge, although the indicia can be located at other portions of the note. In use, a consumer would generally fold the note forward so that the bottom edge lies just below the pre-printed indicia.

In an alternate embodiment of FIG. 2, the first privacy adhesive is disposed along the first and second side edges of the note in the top portion and or in the bottom portion of the note. Typically, the first privacy adhesive is disposed along the side edges in the bottom portion of the note. The first privacy adhesive can span the entire length of the side edges of the bottom portion. Optionally, perforations can be added extending generally parallel to the first adhesive such that it would be sandwiched between the perforation and the first or second side edge.

FIGS. 3a, 3b, and 3c show schematic views of a repositionable privacy note 30 in use. The note 30 is similar to the note 20 of FIG. 2. A consumer transcribes a private message onto the first side 32a of a substrate 32. After completion of the message, she folds the note forward, as indicated by the arrow A, along a folding region (not shown) so that the first side of the bottom portion is proximate to the first side top portion thereby concealing a major portion, and typically all, of the message. In FIG. 3c, the note is ready for display, and as can be seen, the message has been concealed due to the folding and attaching of the bottom portion to the top portion of the note. The folding process necessarily brings the first surface of the top portion proximate to, if not in contact with, the first surface of the bottom portion. The note is folded such that the first release coating, disposed generally below pre-printed indicia 39, remains exposed. The note along with its concealed message can be attached to a display surface, such as, e.g., a door, a wall, a document holder, or a computer, for the intended recipient.

FIG. 4 shows cross-sectional view of a pad 40 that contains a plurality of individual repositionable privacy notes. For ease of understanding, only two notes are shown. The first note has a first substrate 42 having first and second surfaces 42a, 42b and top and bottom edges 42c, 42d. A first privacy adhesive 46 is disposed on the first surface of the substrate proximate to the bottom edge. A repositionable adhesive 44 is disposed on the second surface of the substrate proximate to the tope edge. A first release coating 48 is disposed on the first surface of substrate proximate to the top edge and opposing the repositionable adhesive. Optionally, a second release coating 43 is disposed on the second surface proximate to the bottom edge of the substrate and opposing the first privacy adhesive. The second note has a second substrate 52 and its construction is substantially the same as that of the first note. When stacked together to form the pad 40, the repositionable adhesive 44 of the first note contacts the first release coating 58 of the second note. Furthermore, first privacy adhesive 56 of the second note contacts second release coating 43 of the first note, if used. In this pad construction, the repositionable adhesive of each note are aligned at one end of the pad.

FIG. 5 shows a top plan view of another exemplary repositionable privacy note 50. FIG. 6 shows a cross-sectional view of the embodiment of FIG. 5 taken along line 6-6. The note includes a substrate 52 having opposing first and second surfaces, 52a and 52b respectively, and top and bottom edges, 52c and 52d respectively. A first privacy adhesive 56 is disposed on the first surface of the substrate proximate to the bottom edge. A repositionable adhesive 54 is disposed on the second surface of the substrate proximate to the top edge. The note also includes a first release coating 58 disposed on the first surface of the substrate proximate to the top edge. A second privacy adhesive 57 is disposed proximate the first release coating and distal from the top edge. Thus, the first release coating is sandwiched between the second privacy adhesive and the top edge of the note. A folding region, generally designated as line 55, divides the note into a top portion, between the folding region and the top edge, and a bottom portion, between the folding region and the bottom edge. Reference numbers 52a₁ and 52a₂ denote the first surface of the top portion and the first surface of the bottom portion, respectively. Optionally, the folding region can be in the form of a pre-printed line, a scored line, or a perforated line, indicating to the user the intended folding area on the note.

In one embodiment, the first and second privacy adhesive, 56, 57, are not pressure sensitive adhesives and thus do not exhibit tack. As used herein, the term “tack” means generally a material that is aggressively and permanently tacky in dry form (i.e., solvent free) at room temperature and firmly adheres to a variety of different surfaces, such as, but not limited to, a user's body or body parts, writing utensils, and common work surfaces, such as tabletops, and paper. However, the first and second privacy adhesives adhere to each other under hand pressure. This type of construction allows for single sheet dispensing from a pad of notes without the need for a second release coating disposed on the second surface of the substrate. For this particular construction to be most effective, the first privacy adhesive contacts the second privacy adhesive. In one embodiment, the first and second privacy adhesives are substantially similar in composition. In one embodiment, the first and second privacy adhesives are derived from a natural latex adhesive composition. In another embodiment, the first and second privacy adhesives are aggressive enough to allow for opening of the note and yet provide for tamper proof evidence. In other words, upon a first disassembly of the note, there are indications, such as significant curl in the substrate or even a tear in the substrate, to alert a recipient that the note has been opened.

FIG. 7 shows a top plan view of another exemplary repositionable privacy note 70. FIG. 8 shows a cross-sectional view of the embodiment of FIG. 7 taken along line 8-8. The note includes a substrate 72 having opposing first and second surfaces, 72a and 72b respectively, and top and bottom edges, 72c and 72d respectively. A first privacy adhesive 76 is disposed on the first surface of the substrate proximate to the bottom edge. A repositionable adhesive 74 is disposed on the second surface of the substrate proximate to the top edge. The note also includes a first release coating 78 disposed on the first surface proximate to the top edge. A primer coating 77 is disposed proximate the first release coating and distal to the top edge. That is, the first release coating is sandwiched between the primer coating and the top edge. A folding region, generally designated as reference number 75, divides the note into a top portion, between the folding region and the top edge, and a bottom portion, between the folding region and the bottom edge. The first privacy adhesive and perforations 71 extend from a first to a second side edge, 72e, 72f. In this particular embodiment, the first privacy adhesive is sandwiched between the perforations and the bottom edge of the substrate. In use when finished with a message, the user folds the note along the folding region so that the first privacy adhesive comes into contact with the primer coating. Because the first privacy adhesive adheres aggressively to the primer coating, to open the note, the recipient tears along the perforations. This feature provides tamper proof evidence should a third party intercept the note before an intended recipient receives the note.

FIGS. 9 and 10 show various views of yet another exemplary repositionable note 90 at different stages of the folding process where a portion of the note is folded over itself. In FIG. 9, after a message has been transcribed, the user folds the note forward (as indicated by arrow B) along a folding region, generally denoted as reference number 95. The user also folds along perforations 91 to create a flap 101 between the perforation and a bottom edge 92d of the substrate. At this stage, the message, written on first surface 92a, is nearly concealed. FIG. 10 shows a cross-sectional view of the note 90 in a partially completely folded state. An optional first privacy adhesive 96, disposed on a first surface 92a of the substrate, lies on the flap. The flap is folded over (as indicated by arrow C) and wrapped around a top edge 92c of the substrate. In the completely folded state, the first privacy adhesive adheres to a repositionable adhesive 94. In this particular embodiment, the repositionable adhesive has a larger surface area than the first privacy adhesive. When the note is completely folded, there is an open area of the repositionable adhesive that can be used for attaching the folded note to an intended surface. For example, the repositionable adhesive can have a surface area that is about twice as larger as that of the surface area of the first privacy adhesive. A first release coating 98 is disposed on the first surface of the substrate opposing the repositionable adhesive. In yet another embodiment, the first privacy adhesive may be replaced with an optional primer coating that is intended to adhere aggressively with the repositionable adhesive thereby providing the added feature of tamper proof, as the note will typically be opened by tearing along the perforations.

FIG. 11 shows a top plan view of yet another exemplary repositionable privacy note 190. FIG. 12 shows a cross-sectional view of the embodiment of FIG. 11 taken along line 12-12. The note includes a substrate 192 having opposing first and second surfaces, 192a and 192b respectively, and top and bottom edges, 192c and 192d respectively. Disposed on the first surface of the substrate proximate the bottom edge are a plurality of openings 200 in the substrate and a primer coating 196 extending from the bottom edge to an imaginary line 191. While FIGS. 9-11 and 10-14 show circular shaped openings, any shape, including but not limited to, polygon-based shapes, can be used. In an alternative embodiment, the imaginary line 191 is replaced with a line of perforations in the substrate extending from a first side edge to a second side edge of the substrate. A repositionable adhesive 194 is disposed on the second surface of the substrate proximate to the top edge. The note also includes a release coating 198 disposed on the first surface of the substrate proximate to the top edge. A folding region, generally denoted by reference number 195, divides the note into a top portion, between the folding region and the top edge, and a bottom portion, between the fold line and the bottom edge.

FIG. 13 shows a schematic view of the note of FIG. 11 in a partially folded state. After a message has been transcribed on the first surface 192a, the user folds the note forward (as indicated by arrow D) along folding region 195. The user also folds along line 191 (as indicated by arrow E) to create a flap 201 between the bottom edge 192d and the line 191. In an alternate embodiment, the line 191 can be replaced with perforations. FIG. 14 shows a plan view of the back of the repositionable note 190 in a completely folded state. The flap 201 has covered a portion of the repositionable adhesive 194 leaving a portion of the adhesive exposed (the area that is in the openings 200) thereby allowing for attachment of the folded note to an intended surface. In the completely folded state, the repositionable adhesive is, in effect, recessed, i.e., set inward by a depth substantially equal to the thickness of the substrate.

There are various alternatives to the embodiments described in the figures. For example, in the embodiment of FIG. 5, the non-tacky adhesive 56 and 57 can be replaced with self-mating mechanical fasteners. Such mechanical fasteners are typically formed with a polymeric base and a plurality of self-mating, typically polymeric, pins protruding from a first side of the base. An opposing second side of the base typically contains a pressure sensitive adhesive that allows for attachment of the mechanical fastener to the substrate. Illustrative mechanical fasteners is disclosed in WO 2006/014239, which is incorporated by reference in its entirety. Furthermore, many of the embodiments show that the first privacy adhesive and second privacy adhesive, if used, span the entire length (i.e., forms a stripe) of the substrate from a first side edge to the a second side edge. The adhesive stripes can be replaced with a central dot of adhesive or multiple dots of adhesive.

Furthermore, while the main message of the repositionable privacy note is written on the first surface of the substrate, the second surface can contain indicia, either pre-printed or handwritten indicia. For example, in FIG. 3b, on second surface 32b₂ of the bottom portion of the note, the user can additionally handwrite an additional comment, such as marking the note “Personal”. Alternatively the note can have a pre-printed “Personal” or “Privacy Note” marking. The additional marking or writing affords additional privacy to the message because at least a portion of the message written on the first surface of the note has been obscured and cannot be read through the substrate. The pre-printed marking can be in registration to ensure that it is generally located in one particular area of the note from one note to the next note, or it can be random, non-registered printing. Multiple markings can be printed as well.

Suitable substrates for use in the present invention can be constructed from a variety of materials including, e.g., paper, plastic (including foams and non-wovens), and textiles (wovens). The term “plastic” means generally thermoplastic and thermoset polymers that can be made into films or sheets. The term “textiles” means generally woven materials or fabrics of natural fibers, artificial fibers, or a combination thereof. In one preferred embodiment, the substrate is paper, much like the paper currently used on Post-it® Notes from 3M Company.

Suitable plastics would include, e.g., polyolefin, polyester, polystyrene, polyamide, (covered by polyolefin category—PE & PP, etc) polyurethane and copolymers thereof. These materials may optionally be compounded with white pigment, nanoparticles or vesicles to mimic the appearance of paper. Plastics further include single and multilayer film constructions of one or more polymer materials, including blends, composites, and copolymers. The plastic films may be chemically or mechanically (calendaring, orienting) modified to mimic paper like performance with the added benefit of enhanced moisture and curl resistance, when compared to paper substrates.

While the figures generally depict that the substrate of rectangular geometry, any shape can be used. Typical polygon based shapes includes square and hexagon. Circles and or irregular shaped substrates, such as, e.g., flowers, stars, and hearts, can also be used. In any of the substrates used for the present invention, there will be regions in the substrate that can be designated as top and bottom edges and first and second side edges. These edges can, but do not need to be, straight edges or edges that are parallel to one another.

The repositionable adhesive is a repositionable pressure sensitive adhesive that is disposed on the second surface of the substrate. One suitable repositionable adhesive is a microsphere adhesive. An exemplary microsphere adhesive includes polyacrylic derivatives. The repositionable adhesive can be solvent based, water based, or can be a solventless, hot melt adhesive. Suitable repositionable adhesives includes those disclosed in the following US Patents: U.S. Pat. No. 3,691,140 (Silver); U.S. Pat. No. 3,857,731 (Merrill et al.); U.S. Pat. No. 4,166,152 (Baker et al.); U.S. Pat. No. 4,495,318 (Howard); U.S. Pat. No. 5,045,569 (Delagado); U.S. Pat. No. 5,073,457 (Blackwell) and U.S. Pat. No. 5,571,617 (Cooprider et al.), U.S. Pat. No. 5,663,241 (Takamatsu et al.); U.S. Pat. No. 5,714,327 (Cooprider et al.); U.S. RE 37,563 (Cooprider et al.); and U.S. Pat. No. 5,756,625 (Crandall et al.); U.S. Pat. No. 5,824,748 (Kesti et al.); and U.S. Pat. No. 5,877,252 (Tsujimoto et al.).

The first and or second privacy adhesive (if used) can be selected from the following types of adhesives: (1) recessed type adhesives disclosed in publication WO2005/077672, which is incorporated by reference in its entirety; particularly useful embodiments include those shown in FIGS. 21 to 28 inclusive, (2) pressure sensitive adhesives, and (3) repositionable adhesives as listed above for the repositionable adhesive.

There are a variety of materials that can be used as the first and or second release coating (if used). Suitable examples include, but are not limited to, those that are based on straight chain alkane derivatives, polydialkyl siloxane derivatives, or fluorocarbon derivatives. Exemplary release coatings are described in U.S. Pat. No. 5,032,460 (Kantner et al.); and U.S. Pat. No. 6,352,766 (Crandall et al.).

### EXAMPLES

### Example 1

Sheets of 7.6 cm wide by 17.8 cm long paper including a 2.5 cm repositionable adhesive coated on a second surface near a top edge of the sheet was provided. The repositionable adhesive, a polyacrylic microsphere-based adhesive, was made according to U.S. Pat. No. 5,824,748 (Kesti et al.). Domtar, Inc., Canada, supplied the paper.

A first privacy adhesive, attached to a first surface near the bottom edge of the sheet, was made as follows. A 2 cm wide by 7.6 cm in length repositionable transfer adhesive tape, Product No. 9415, available from 3M Company, was laminated to the sheet with a repositionable adhesive side of the transfer tape exposed and the permanent adhesive side attached to the sheet. Two strips of 6 mm wide packaging tape, Product No. 371, from 3M Company, were laminated to the longitudinal edge of the repositionable transfer tape to provide standoffs. A perforation was made near the first privacy adhesive across the width of the paper using a handheld aluminum saw tooth blade having a 2 cm diameter. Ten sheets were stacked with the repositionable adhesive aligned at one end. The sheets were pressed (at the top edge where the repositionable adhesive is located) using a press at 3,000 psi at room temperature for 30 second to make a pad of repositionable privacy notes.

### Example 2

Square sheets of paper of Example 1 were provided.

To the first surface (i.e., the primary writing surface) of the sheet, two stripes of natural rubber latex material were coated using a hand coater. The hand coater included a knife set at a gap of 0.45 mm. A first stripe of latex was coated near the bottom edge of the sheet and upon drying in an oven set at 65° for 30 minutes, yielded a first privacy adhesive. A second stripe of latex was coated at 2.5 cm from the top edge, and dried at the same conditions recited above, to yield a second privacy adhesive. The second privacy adhesive lies just beyond the second repositionable pre-coated on the opposing second surface. The resulting privacy note was similar to that shown in FIG. 5.

After the latex stripes were dried, the sheets were cut using a paper cutter to a width of 2 cm and a length of 7.6 cm. Ten sheets were stacked with the repositionable adhesive aligned at one end and the first privacy adhesive aligned at the opposing end. The sheets were pressed together as in Example 1 to form a pad of repositionable privacy notes.

A first sheet from the pad was removed. A message was inscribed on the first surface of the sheet. A bottom portion of the sheet was folded forward such that the first and second privacy adhesive came into contact. The resulting note was attached to a wall with its message concealed. At a later time, the note was removed and the message revealed by peeling the folded portion of the note using hand pressure.

Although specific embodiments of the present invention have been shown and described, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A repositionable privacy note comprising:
a substrate having opposing first and second surfaces, top and bottom edges, and a folding region disposed therebetween creating in the note a top portion between the folding region and the top edge and a bottom portion between the folding region and the bottom edge;
a first privacy adhesive disposed on the first surface of the substrate; and
a repositionable adhesive disposed on the second surface of the substrate.

2. The repositionable privacy note of claim 1 further comprising a first release coating disposed on the first surface of the substrate opposing the repositionable adhesive.

3. The repositionable privacy note of claim 1, wherein the first privacy adhesive is disposed near the bottom edge and the repositionable adhesive is disposed near the top edge of the substrate.

4. The repositionable privacy note of claim 1, wherein at least one of the first privacy adhesive, the repositionable adhesive, and the first release coating spans from a first side edge to a second side edge of the substrate.

5. The repositionable privacy note of claim 1, wherein the first privacy adhesive is disposed in at least one of the top and bottom portion along a first side edge and a second side edge of the note.

6. The repositionable privacy note of claim 1 further comprising a second release coating disposed on the second surface of the substrate opposing the first privacy adhesive.

7. The repositionable privacy note of claim 1, wherein the first privacy adhesive is selected from the group consisting of repositionable adhesive and pressure sensitive adhesive.

8. The repositionable privacy note of claim 1 wherein the top portion is larger than the bottom portion.

9. The repositionable privacy note of claim 1 further including pre-printed indicia disposed near the top edge on the first surface of the substrate.

10. The repositionable privacy note of claim 3 further comprising a perforation adjacent to the first privacy adhesive and distal to the bottom edge of the substrate.

11. The repositionable privacy note of claim 2 further comprising a second privacy adhesive disposed on the first surface of the substrate.

12. The repositionable privacy note of claim 11, wherein the second privacy adhesive is disposed adjacent to the first release coating and distal to the top edge of the substrate.

13. The repositionable privacy note of claim 11 wherein the first and second privacy adhesives are substantially similar and are tacky to each other.

14. The repositionable privacy note of claim 11 wherein the first and second privacy adhesives are natural latex rubber.

15. The repositionable privacy note of claim 11 further comprising a perforation extending from a first side edge to a second side edge of the substrate, the perforation disposed adjacent to the first privacy adhesive and distal to the bottom edge of the substrate.

16. The repositionable privacy note of claim 1, wherein the first privacy adhesive is a recessed adhesive.

17. The repositionable privacy note of claim 2 further comprising a primer coating disposed on the first surface of the substrate adjacent to the first release coating and distal to the top edge of the substrate.

18. The repositionable privacy note of claim 17 further comprising a perforation extending from a first side edge to a second side edge of the substrate, the perforation disposed adjacent to the first privacy adhesive and distal to the bottom edge of the substrate.

19. The repositionable note of claim 1 further comprising indicia in the bottom portion and on the second surface of the substrate.

20. A pad comprising a plurality of privacy notes of claim 1, wherein the repositionable adhesive on each note is aligned at one end of the pad.

21. A method of using a repositionable privacy note comprising the steps of:
providing a repositionable privacy note of claim 1;
transcribing a message on the first surface of the substrate;
folding the note such that the first surface of the top portion is proximate to the first surface of the bottom portion; and
adhering the note to a display surface such that the repositionable adhesive contacts the display surface.

22. The method of claim 21 further comprising the step of transcribing a second message on the second surface of the bottom portion of the note.

23. A repositionable privacy note comprising:
a substrate having opposing first and second surfaces, top and bottom edges, and a folding region disposed therebetween creating in the note a top portion between the folding region and the top edge and a bottom portion between the folding region and the bottom edge;
means for attaching the top portion to the bottom portion such that their respective first surfaces are proximate to each other;
a repositionable adhesive disposed on the second surface of the substrate near the top edge; and
a first release coating disposed on the first surface of the substrate opposing the repositionable adhesive.

24. The repositionable privacy note of claim 23, wherein when the note is in a completely folded state, the means for attaching the top portion to the bottom portion is not disposed on the first release coating.

25. The repositionable privacy note of claim 23, wherein the means for attaching the top portion to the bottom portion is disposed near the bottom edge of the substrate and spans from a first side edge to a second side edge of the substrate.

26. The repositionable privacy note of claim 23 wherein the means for attaching the top portion to the bottom portion is selected from the group consisting of a pressure sensitive adhesive, a repositionable adhesive, a mechanical fastener, a recessed adhesive, a non-tacky adhesive, and combinations thereof.

27. The repositionable privacy note of claim 26, wherein the mechanical fastener is a first self mating fastener disposed near the bottom edge of the substrate, spans from a first side edge to a second side edge of the substrate, and in the top portion of the note is disposed a corresponding second self mating fastener for engagement with the first self mating fastener.

28. The repositionable privacy note of claim 25, wherein the means for attaching the top portion to the bottom portion comprises a first privacy adhesive disposed near the bottom edge and a second privacy adhesive disposed in the top portion of the note, wherein the first and second privacy adhesives are non-tacky adhesives and yet tacky to each other.

29. The repositionable privacy note of claim 23 further comprising pre-printed indicia disposed on at least one of the first surface of the top portion and the second surface of the bottom portion of the note.

30. A repositionable privacy note comprising:
a substrate having opposing first and second surfaces, top and bottom edges, and a folding region disposed therebetween creating in the note a top portion between the folding region and the top edge and a bottom portion between the folding region and the bottom edge;
a plurality of openings in the substrate disposed near the bottom edge of the substrate;
a primer coating disposed on the first surface covering the substrate at least in between the openings; and
a repositionable adhesive disposed on the second surface of the substrate.

31. The repositionable privacy note of claim 30, wherein the repositionable adhesive is disposed near the top edge of the substrate.

32. The repositionable privacy note of claim 30 further comprising a first release coating disposed on the first surface of the substrate opposing the repositionable adhesive.

33. The repositionable privacy note of claim 30 further comprising a perforation disposed adjacent to the primer coating and distal from the bottom edge of the substrate.

34. The repositionable privacy note of claim 30, wherein the primer coating surrounds the opening.

35. The repositionable privacy note of claim 30, wherein at least one of the opening and the primer coating spans a first side edge to a second side edge of the note.

36. The repositionable privacy note of claim 30, wherein the openings are circular in shape, polygonal in shape, and combinations thereof.

37. A method of using a repositionable privacy note comprising the steps of:
providing the note of claim 30;
transcribing a message on a first surface of the substrate;
folding the note such that the first surface of the top portion is proximate to the first surface of the bottom portion;
creasing the note so as to create a flap near the bottom edge of the note, the flap comprising the openings and the primer coating;
folding the flap over the top edge of the substrate;
adhering the flap such that the primer coating contacts the repositionable adhesive creating a folded note; and
adhering the folded note to a display surface.

38. The method of claim 37 further comprising the step of transcribing a second message to the second surface of the bottom portion of the note.

39. A pad comprising a plurality of repositionable privacy note of claim 30, wherein the repositionable adhesive of each note in the pad are aligned at one end of the pad.
